(19) United States
(12) Patent Application Publication
(10) Pub. No.: US 2014/0235402 A1
(43) Pub. Date: Aug. 21, 2014

(54) VEHICLE DRIVE DEVICE

(71) Applicants: Tomoya Matsubara, Nagoya-shi (JP); Isao Sato, Nagoya-shi (JP); Satoru Takahashi, Nisshin-shi (JP)

(72) Inventors: Tomoya Matsubara, Nagoya-shi (JP); Isao Sato, Nagoya-shi (JP); Satoru Takahashi, Nisshin-shi (JP)

(73) Assignee: TOYOTA JIDOSHA KABUSHIKI KAISHA, Toyota-shi, Aichi (JP)

(21) Appl. No.: 14/345,787

(22) PCT Filed: Sep. 20, 2011
(86) PCT No.: PCT/JP2011/071405

§ 371 Date: Apr. 16, 2014

(51) Int. Cl. B60W 10/11; B60W 10/08

(52) U.S. Cl. CPC B60W 10/11; B60W 10/08; B60W 2510/08; B60W 2510/10
USPC 477/8

(57) ABSTRACT

A vehicle drive device comprises: an electric motor as a drive force source for running, the vehicle drive device further comprising one end portion of an output rotating member of the electric motor being coupled to first drive wheels via a first power connecting/disconnecting device selectively interrupting power transmission, the other end portion of the output rotating member being coupled to second drive wheels through a second power connecting/disconnecting device selectively interrupting power transmission at a shift ratio different from a shift ratio between the one end portion and the first drive wheels, and the first power connecting/disconnecting device and the second power connecting/disconnecting device being alternatively put into a power transmittable state of transmitting power so as to shift gears between the first drive wheels or the second drive wheels and the electric motor.

### TECHNICAL FIELD

The present invention relates to a mechanical configuration of a vehicle drive device including an electric motor outputting power toward drive wheels.

### BACKGROUND ART

A vehicle drive device is conventionally known that includes an electric motor as a drive force source for running. For example, this corresponds to an electric vehicle drive device described in Patent Document 1. The electric vehicle drive device of Patent Document 1 has an output rotating member of the electric motor, i.e., one end portion of an electric motor output shaft, coupled via a deceleration mechanism to drive wheels. On the other hand, the other end portion of the electric motor output shaft is not coupled to the drive wheels. Therefore, the power of the electric motor is transmitted only from the one end portion of the electric motor output shaft toward the drive wheels and is not transmitted from the other end portion of the electric motor output shaft toward the drive wheels.

### PRIOR ART DOCUMENTS

### Patent Documents

Patent Document 1: Japanese Laid-Open Patent Publication No. 10-278603

Patent Document 2: Japanese Laid-Open Patent Publication No. 06-080036

Patent Document 3: Japanese Laid-Open Patent Publication No. 2006-062571

### SUMMARY OF THE INVENTION

### Problems to Be Solved by the Invention

In a configuration of transmitting the power of the electric motor only from the one end portion of the electric motor output shaft toward the drive wheels as in the electric vehicle drive device of Patent Document 1 described above, a power transmission mechanism transmitting the power, for example, the deceleration mechanism and a transmission are arranged on the one end portion side in a biased manner and are not arranged on the other end portion side of the electric motor output shaft. Therefore, the power transmission mechanism is axially enlarged only on the one end portion side of the electric motor output shaft. This leads to greater restriction when the power transmission mechanism is mounted on a vehicle, causing an unknown problem of inability to define a mounting position of the electric motor at a desired position in the vehicle. To satisfy both high drive torque and high speed running of a vehicle while achieving reduction in size of an electric motor, it is contemplated that a gear shift mechanism of some sort must be disposed.

The present invention was conceived in view of the situations and it is therefore an object of the present invention to provide a vehicle drive device including an electric motor as a drive force source for running and capable of reducing design restriction on a mounting position of the electric motor.

### Means for Solving the Problem

To achieve the object, the first aspect of the invention provides a vehicle drive device (a) comprising: an electric motor as a drive force source for running, wherein (b) one end portion of an output rotating member of the electric motor is coupled to first drive wheels via a first power connecting/disconnecting device selectively interrupting power transmission, wherein the other end portion of the output rotating member is coupled to second drive wheels through a second power connecting/disconnecting device selectively interrupting power transmission at a shift ratio different from a shift ratio between the one end portion and the first drive wheels, and wherein (c) the first power connecting/disconnecting device and the second power connecting/disconnecting device are alternatively put into a power transmittable state of transmitting power so as to shift gears between the first drive wheels or the second drive wheels and the electric motor.

### Effects of the Invention

Consequently, with regard to the power transmission mechanism transmitting the power of the electric motor to the first drive wheels or the second drive wheels, enlargement is prevented from occurring on the side of the one end portion of the output rotating member of the electric motor in a biased manner and, therefore, the design restriction on the mounting position of the electric motor in the vehicle can be reduced as compared to the case of disposing a stepped transmission only on the side of the one end portion of the output rotating member, for example. In other words, a degree of freedom of design related to the mounting position of the electric motor is increased. A rotation speed of the electric motor can be changed at shift ratios different from each other for running the vehicle. Moreover, by coupling only the one end portion of the output rotating member of the electric motor through the first power connecting/disconnecting device to the first drive wheels or by coupling only the other end portion of the output rotating member of the electric motor through the second power connecting/disconnecting device to the second drive wheels, the first drive wheels and the second drive wheels can alternatively be driven.

The second aspect of the invention provides the vehicle drive device recited in the first aspect of the invention, wherein (a) the one end portion of the output rotating member is coupled through the first power connecting/disconnecting device and a four-wheel drive power connecting/disconnecting device in series to the second drive wheels, and wherein (b) the four-wheel drive power connecting/disconnecting device selectively interrupts power transmission from the first power connecting/disconnecting device to the second drive wheels. Consequently, in a running state of transmitting the power of the electric motor from the one end portion of the output rotating member to the first drive wheels, the power of the electric motor can selectively be transmitted by the four-wheel drive power connecting/disconnecting device to the second drive wheels as well, thereby putting the vehicle into a four-wheel drive state.

The third aspect of the invention provides the vehicle drive device recited in the second aspect of the invention, wherein (a) the other end portion of the output rotating member is coupled through the second power connecting/disconnecting device and the four-wheel drive power connecting/disconnecting device in series to the first drive wheels, and wherein (b) the four-wheel drive power connecting/disconnecting device selectively interrupts power transmission from the second power connecting/disconnecting device to the first drive wheels. Consequently, in a running state of transmitting the power of the electric motor from the other end portion of the output rotating member to the second drive wheels, the power of the electric motor can selectively be transmitted by the four-wheel drive power connecting/disconnecting device to the first drive wheels as well, thereby putting the vehicle into the four-wheel drive state. In other words, if the vehicle is put into the four-wheel drive state by the four-wheel drive power connecting/disconnecting device, a gear change can be made between the electric motor and the first/second drive wheels by the first power connecting/disconnecting device and the second power connecting/disconnecting device.

The fourth aspect of the invention provides the vehicle drive device recited in the first aspect of the invention, wherein (a) a transmission capable of varying a shift ratio is disposed between the one end portion of the output rotating member and the first drive wheels, and wherein (b) the transmission is shifted to set a shift ratio between the one end portion of the output rotating member and the first drive wheels and a shift ratio between the other end portion of the output rotating member and the second drive wheels to the same shift ratio as each other. Consequently, after the transmission is shifted such that the shift ratio between the one end portion of the output rotating member and the first drive wheels is set to the same shift ratio as the shift ratio between the other end portion of the output rotating member and the second drive wheels, the vehicle can be put into the four-wheel drive state by coupling the one end portion of the output rotating member to the first drive wheels through the first power connecting/disconnecting device and coupling the other end portion of the output rotating member to the second drive wheels through the second power connecting/disconnecting device.

The fifth aspect of the invention provides the vehicle drive device recited in the first aspect of the invention, wherein (a) the one end portion of the output rotating member is coupled to the first drive wheels sequentially through the first power connecting/disconnecting device, a first reduction gear, and a third power connecting/disconnecting device selectively interrupting power transmission, wherein the other end portion of the output rotating member is coupled to the second drive wheels sequentially through the second power connecting/disconnecting device, a second reduction gear, and a fourth power connecting/disconnecting device selectively interrupting power transmission, and wherein (b) the first drive wheel side of the first reduction gear and the second drive wheel side of the second reduction gear are coupled to each other through a fifth power connecting/disconnecting device selectively interrupting power transmission and a third reduction gear in series. Consequently, a first shift stage with the one end portion of the output rotating member coupled through the first reduction gear and the third reduction gear in series to the second drive wheels, a second shift stage with the one end portion of the output rotating member coupled through the first reduction gear to the first drive wheels, a third shift stage with the other end portion of the output rotating member coupled through the second reduction gear to the second drive wheels, and a fourth shift stage with the other end portion of the output rotating member coupled through the second reduction gear and the third reduction gear in series to the first drive wheels can be alternatively established, gear changes can be made in a total of four speeds. When the second shift stage or the third shift stage is established, the fifth power connecting/disconnecting device can be slipped to transmit power so as to put the vehicle into the four-wheel drive state.

Preferably, the first drive wheels correspond to front wheels and the second drive wheels correspond to rear wheels.

### BRIEF DESCRIPTION OF THE DRAWINGS

FIG. 1 is a schematic for explaining a vehicle drive device of first example.

FIG. 2 is a schematic for explaining a vehicle drive device of second example.

FIG. 3 is a schematic for explaining a vehicle drive device of third example.

FIG. 4 is an engagement table for explaining a relationship between alternatively established shift stages and engagement states of first to fifth clutches in a gear shifting device made up of the first to fifth clutches, the first reduction gear, the second reduction gear, and the third reduction gear and included in the vehicle drive device of FIG. 3.

FIG. 5 is a schematic for explaining a vehicle drive device with the third clutch, the fourth clutch, and the third reduction gear removed from the vehicle drive device of FIG. 3.

### MODE FOR CARRYING OUT THE INVENTION

An example of the present invention will now be described in detail with reference to the drawings.

### First Example

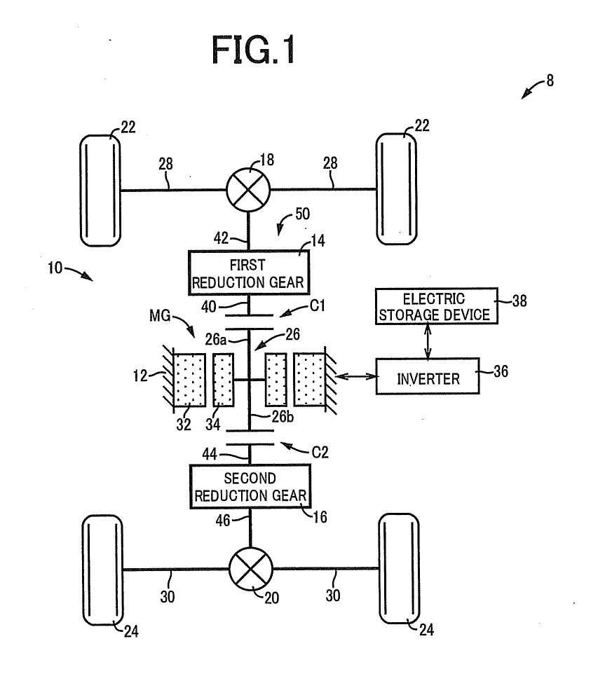

FIG. 1 is a schematic for explaining a vehicle drive device 10 to which the present invention is applied. The vehicle drive device 10 is preferably used in an electric vehicle 8 (hereinafter referred to as a vehicle 8) running with power of an electric motor MG

As depicted in FIG. 1, the vehicle drive device 10 has a transaxle case 12 (hereinafter referred to as a “case 12”) as a non-rotating member attached to a vehicle body by bolts etc., and includes the electric motor MG; a first reduction gear 14, a second reduction gear 16, a first clutch C1, and a second clutch C2 in the case 12 that is a housing of the vehicle drive device 10. The vehicle drive device 10 also includes a first differential gear device 18 (first differential gear 18) and a second differential gear device 20 (second differential gear 20) outside the case 12. For example, the electric motor MG is disposed between front wheels 22 and rear wheels 24 such that an axial direction of the electric motor MG matches a longitudinal direction of the vehicle 8. When the power of the electric motor MG is transmitted to the front wheels 22 that are first drive wheels in the vehicle 8, the first clutch C1 is engaged and the second clutch C2 is released. As a result, the power of the electric motor MG is transmitted from an output rotating member 26 of the electric motor MG, or specifically, one end portion 26a of the output rotating member 26, sequentially through the first clutch C1, the first reduction gear 14, the first differential gear device 18, and a pair of first drive axles 28 (first drive shafts 28) respectively coupling the first differential gear device 18 and a pair of the front wheels 22, to the pair of the front wheels 22. Conversely, when the power of the electric motor MG is transmitted to the rear wheels 24 that are second drive wheels, the first clutch C1 is released and the second clutch C2 is engaged. As a result, the power of the electric motor MG is transmitted from the output rotating member 26 of the electric motor MG; or specifically, another end portion 26b of the output rotating member 26, sequentially through the second clutch C2, the second reduction gear 16, the second differential gear device 20, and a pair of second drive axles 30 (second drive shafts 30) respectively coupling the second differential gear device 20 and a pair of the rear wheels 24, to the pair of the rear wheels 24. Therefore, a power transmission path from the one end portion 26a of the output rotating member 26 of the electric motor MG to the front wheels 22 has the one end portion 26a, the first clutch C1, the first reduction gear 14, the first differential gear device 18, the first drive axles 28, and the front wheels 22 sequentially coupled in series. On the other hand, a power transmission path from the other end portion 26b of the output rotating member 26 to the rear wheels 24 has the other end portion 26b, the second clutch C2, the second reduction gear 16, the second differential gear device 20, the second drive axles 30, and the rear wheels 24 sequentially coupled in series. The first reduction gear 14, the first clutch C1, the electric motor MG; the second clutch C2, and the second reduction gear 16 are arranged in series on a rotation axis of the electric motor MG The front wheels 22 and the rear wheels 24 have the same wheel diameter.

The electric motor MG is disposed on a center portion of the vehicle 8 and is a so-called motor generator having a motor function of outputting the power for vehicle running to at least one of the front wheels 22 and the rear wheels 24 and an electric generation function. Therefore, the electric motor MG acts as a drive force source for running. Specifically, the electric motor MG includes an electric motor stator 32 fixed to the inside of the case 12, an electric motor rotor 34 rotating inside the electric motor stator 32, and the output rotating member 26 rotating integrally with the electric motor rotor 34 and acting as an electric motor output shaft. The electric motor MG is electrically connected via an inverter 36 to an electric storage device 38, and the electric motor MG and the electric storage device 38 are configured such that electric power can mutually be given and received. The electric storage device 38 is, for example, a battery (secondary battery) such as a lead storage battery or an electric energy source such as a capacitor.

The output rotating member 26 of the electric motor MG projects toward the both axial sides of the electric motor MG and the power of the electric motor MG is output from the one end portion 26a and the other end portion 26b of the output rotating member 26. In short, the electric motor MG outputs the power of the electric motor MG to the both axial sides of the electric motor MG. The one end portion 26a of the output rotating member 26 of the electric motor MG acts as a first electric motor output shaft 26a outputting the power of the electric motor MG to the first reduction gear 14, and the other end portion 26b of the output rotating member 26 acts as a second electric motor output shaft 26b outputting the power of the electric motor MG to the second reduction gear 16. Therefore, the first electric motor output shaft 26a and the second electric motor output shaft 26b integrally rotate around the rotation axis of the electric motor MG

The first reduction gear 14 includes a first reduction gear input shaft 40 coupled via the first clutch C1 to the one end portion 26a of the output rotating member 26, and a first reduction gear output shaft 42 coupled to the first differential gear device 18. The first reduction gear 14 includes, for example, a gear device or a belt power transmission device, and changes a rotation speed at a constant first shift ratio γ1 (=rotation speed of the first reduction gear input shaft 40/rotation speed of the first reduction gear output shaft 42) for power transmission between the first reduction gear input shaft 40 and the first reduction gear output shaft 42. The shift ratio is also referred to as a reduction ratio or a gear ratio.

The second reduction gear 16 includes a second reduction gear input shaft 44 coupled via the second clutch C2 to the other end portion 26b of the output rotating member 26, and a second reduction gear output shaft 46 coupled to the second differential gear device 20. The second reduction gear 16 has the same structure as the first reduction gear 14, includes, for example, a gear device or a belt power transmission device, and changes a rotation speed at a constant second shift ratio γ2 (=rotation speed of the second reduction gear input shaft 44/rotation speed of the second reduction gear output shaft 46) for power transmission between the second reduction gear input shaft 44 and the second reduction gear output shaft 46. The second shift ratio γ2 of the second reduction gear 16 is a shift ratio different from the first shift ratio γ1 of the first reduction gear 14. Although the magnitude relation between the both shift ratios γ1 and γ2 is not particularly limited, the first shift ratio γ1 is set to a value greater than the second shift ratio γ2 in this example.

The first clutch C1 and the second clutch C2 are wet multi-plate type hydraulic friction engagement devices in which a plurality of friction plates overlapped with each other is pressed by a hydraulic actuator, and are engaged, released, and slipped by hydraulic control. The first clutch C1 and the second clutch C2 are in a power transmission state of transmitting power when engaged and are in a power transmission interruption state of interrupting power transmission when released. When slipped, the clutches C1 and C2 can adjust a transmittable torque capacity and allow a rotation speed difference between the input/output members. Because of such a configuration, the first clutch C1 interposed between the one end portion 26a of the output rotating member 26 of the electric motor MG and the first reduction gear 14 acts as a first power connecting/disconnecting device selectively interrupting the power transmission between the one end portion 26a and the first reduction gear 14. In other words, the first reduction gear 14 is coupled to the one end portion 26a of the output rotating member 26 in a power connectable/disconnectable manner. The second clutch C2 interposed between the other end portion 26b of the output rotating member 26 and the second reduction gear 16 acts as a second power connecting/disconnecting device selectively interrupting the power transmission between the other end portion 26b and the second reduction gear 16. In other words, the second reduction gear 16 is coupled to the other end portion 26b of the output rotating member 26 in a power connectable/disconnectable manner.

The first differential gear device 18 and the second differential gear device 20 are differential gear devices generally used in a vehicle and transmitting power while allowing a mutual rotation difference of a pair of drive wheels. A shift ratio γdf1 of the first differential gear device 18 (=rotation speed of the first reduction gear output shaft 42/rotation speed of the first drive axles 28) is preliminarily set to the same value as a shift ratio γdf2 of the second differential gear device 20 (=rotation speed of the second reduction gear output shaft 46/rotation speed of the second drive axles 30).

In the vehicle drive device 10 configured as described above, the first reduction gear 14, the second reduction gear 16, the first clutch C1, and the second clutch C2 act as a two-speed gear shifting device 50 alternatively switching the first shift ratio γ1 and the second shift ratio γ2 as a whole. For example, if the first clutch C1 is engaged and the second clutch C2 is released, a shift ratio of the gear shifting device 50 is switched to the first shift ratio γ1 and, conversely, if the first clutch C1 is released and the second clutch C2 is engaged, the shift ratio of the gear shifting device 50 is switched to the second shift ratio γ2. In short, in the vehicle drive device 10, the front wheels (first drive wheels) 22 and the rear wheels (second drive wheels) 24 are alternatively coupled to the output rotating member 26 of the electric motor MG by the first clutch C1 and the second clutch C2 for shifting gears between the front wheels 22 or the rear wheels 24 and the electric motor MG In other words, a shift ratio is switched between the front wheels 22 or the rear wheels 24 to which the power of the electric motor MG is transmitted and the electric motor MG.

When both the first clutch C1 and the second clutch C2 are released, the vehicle drive device 10 enters a neutral state in which the power of the electric motor MG is transmitted to none of the front wheels 22 and the rear wheels 24. Conversely, when both the first clutch C1 and the second clutch C2 are engaged, the front wheels 22 and the rear wheels 24 are locked due to friction with a running road surface even if the electric motor MG is not energized and is in an idly rotatable state. Therefore, the vehicle drive device 10 can produce a hill hold function preventing the vehicle 8 from moving backward on a climbing road, for example. Given that the hill hold function is produced by the engagement of the first clutch C1 and the second clutch C2, the first clutch C1 and the second clutch C2 are preferably of a normally close type engaged when no oil pressure is applied.

The vehicle drive device 10 of this example has the following effects (A1) and (A2). (A1) According to this example, as depicted in FIG. 1, the one end portion 26a of the output rotating member 26 of the electric motor MG is coupled via the first clutch (first power connecting/disconnecting device) C1 to the front wheels (first drive wheels) 22. On the other hand, the other end portion 26b of the output rotating member 26 is coupled via the second clutch (second power connecting/disconnecting device) C2 to the rear wheels (second drive wheels) 24. Since the second shift ratio γ2 of the second reduction gear 16 is different from the first shift ratio γ1 of the first reduction gear 14, the shift ratio between the other end portion 26b and the rear wheels 24 is different from the shift ratio between the one end portion 26a and the front wheels 22. When the first clutch C1 and the second clutch C2 are alternatively engaged, i.e., the power transmission state is alternatively achieved, in the vehicle drive device 10, gears are shifted between the front wheels 22 or the rear wheels 24 and the electric motor MG Therefore, with regard to the gear shifting device 50 that is the power transmission mechanism transmitting the power of the electric motor MG to the front wheels 22 or the rear wheels 24, or specifically, the power transmission mechanism made up of the first reduction gear 14, the second reduction gear 16, the first clutch C1, and the second clutch C2, enlargement is prevented from occurring on the side of the one end portion 26a of the output rotating member 26 of the electric motor MG in a biased manner and, therefore, design restriction on a mounting position of the electric motor MG in the vehicle 8 can be reduced as compared to the case of disposing a stepped transmission only on the side of the one end portion 26a of the output rotating member 26, for example. In other words, a degree of freedom of design related to the mounting position of the electric motor MG is increased. A rotation speed of the electric motor MG can be changed at shift ratios different from each other for running the vehicle 8.

(A2) According to this example, by coupling only the one end portion 26a of the output rotating member 26 of the electric motor MG through the first clutch C1 to the front wheels 22 or by coupling only the other end portion 26b of the output rotating member 26 of the electric motor MG through the second clutch C2 to the rear wheels 24, the front wheels 22 and the rear wheels 24 can alternatively be driven. Therefore, for example, if a drive wheel slips in either the front wheels 22 or the rear wheels 24, the drive wheels associated with the power transmission are switched such that the power of the electric motor MG is transmitted to the other drive wheels so as to cause the other drive wheels to generate a drive force. By switching the drive wheels associated with the power transmission in this way, the running performance of the vehicle 8 can be improved, for example, on a running road on which wheels easily slip, as compared to a two-wheel drive vehicle only either the front wheels 22 or the rear wheels 24 are driven.

Other examples of the present invention will be described. In the following description of the examples, the portions mutually common to the examples are denoted by the same reference numerals and will not be described.

### Second Example

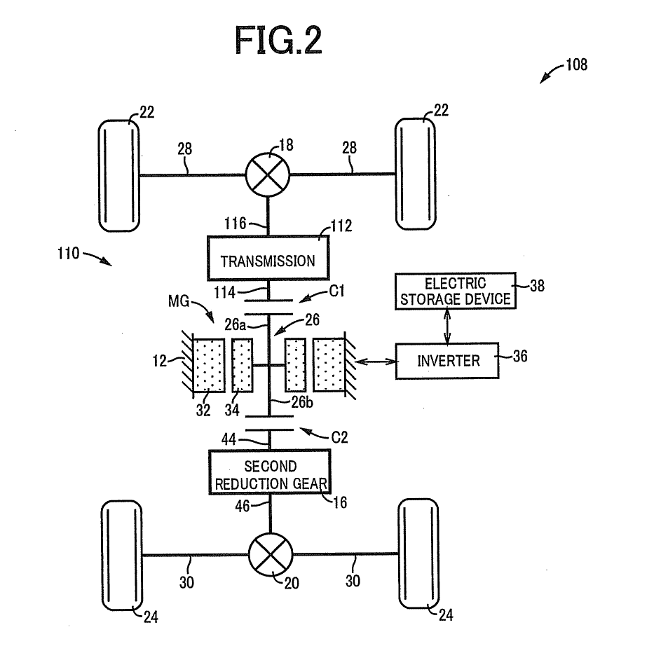

In the description of this example (second example), the points common with the first example will not be described and the points different from the first example will mainly be described. FIG. 2 is a schematic for explaining a vehicle drive device 110 included in an electric vehicle 108 (hereinafter referred to as a vehicle 108) of this example. As can be seen from comparison between FIGS. 1 and 2, the vehicle drive device 110 of this example is different from the vehicle drive device 10 of the first example in that the first reduction gear 14 of the first example is replaced with a transmission 112. The vehicle drive device 110 is the same as the vehicle drive device 10 of the first example except the replacement.

The transmission 112 included in the vehicle drive device 110 is disposed between the one end portion 26a of the output rotating member 26 of the electric motor MG and the front wheels 22, or specifically, disposed between the first clutch C1 and the first differential gear device 18. The transmission 112 includes a transmission input shaft 114 coupled via the first clutch C1 to the one end portion 26a of the output rotating member 26, and a transmission output shaft 116 coupled to the first differential gear device 18, can change a shift ratio between the transmission input shaft 114 and the transmission output shaft 116 (=rotation speed of the transmission input shaft 114/rotation speed of the transmission output shaft 116), and performs power transmission at the selected shift ratio. Specifically, although the transmission 112 may be a manual transmission, the transmission 112 is a stepped automatic transmission automatically making a shift in this example. In other words, the transmission 112 is an automatic transmission mechanism in which any of predefined multiple shift stages (shift ratios) is alternatively established, and includes a plurality of planetary gear devices and pluralities of hydraulically actuated clutches and brakes for performing the shift. Specifically, the transmission 112 is a two-speed automatic transmission. Therefore, the transmission 112 has a first-speed shift stage on the lower vehicle speed side and a second-speed shift stage on the higher vehicle speed side alternatively established, and a shift ratio of the transmission 112 is larger on the first-speed shift stage than the second-speed shift stage. The shift ratio of the transmission 112 corresponding to the first-speed shift stage is set in advance to the same shift ratio as the second shift ratio γ2 of the second reduction gear 16. Therefore, when the transmission 112 is shifted to the first-speed shift stage, the shift ratio between the one end portion 26a of the output rotating member 26 of the electric motor MG and the front wheels 22 is set to the same shift ratio as the shift ratio between the other end portion 26b of the output rotating member 26 and the rear wheels 24.

The vehicle drive device 110 of this example has the following effect in addition to the effects (A1) and (A2) of the first example described above. According to this example, the transmission 112 capable of changing a shift ratio is disposed between the one end portion 26a of the output rotating member 26 of the electric motor MG and the front wheels. 22. By shifting the transmission 112, the shift ratio between the one end portion 26a of the output rotating member 26 and the front wheels 22 is set to the same shift ratio as the shift ratio between the other end portion 26b of the output rotating member 26 and the rear wheels 24. Therefore, after the transmission 112 is shifted such that the shift ratio between the one end portion 26a of the output rotating member 26 and the front wheels 22 is set to the same shift ratio as the shift ratio between the other end portion 26b of the output rotating member 26 and the rear wheels 24, the vehicle 108 can be put into a four-wheel drive state by coupling the one end portion 26a of the output rotating member 26 to the front wheels 22 through the engagement of the first clutch C1 and coupling the other end portion 26b of the output rotating member 26 to the rear wheels 24 through the engagement of the second clutch C2.

### Third Example

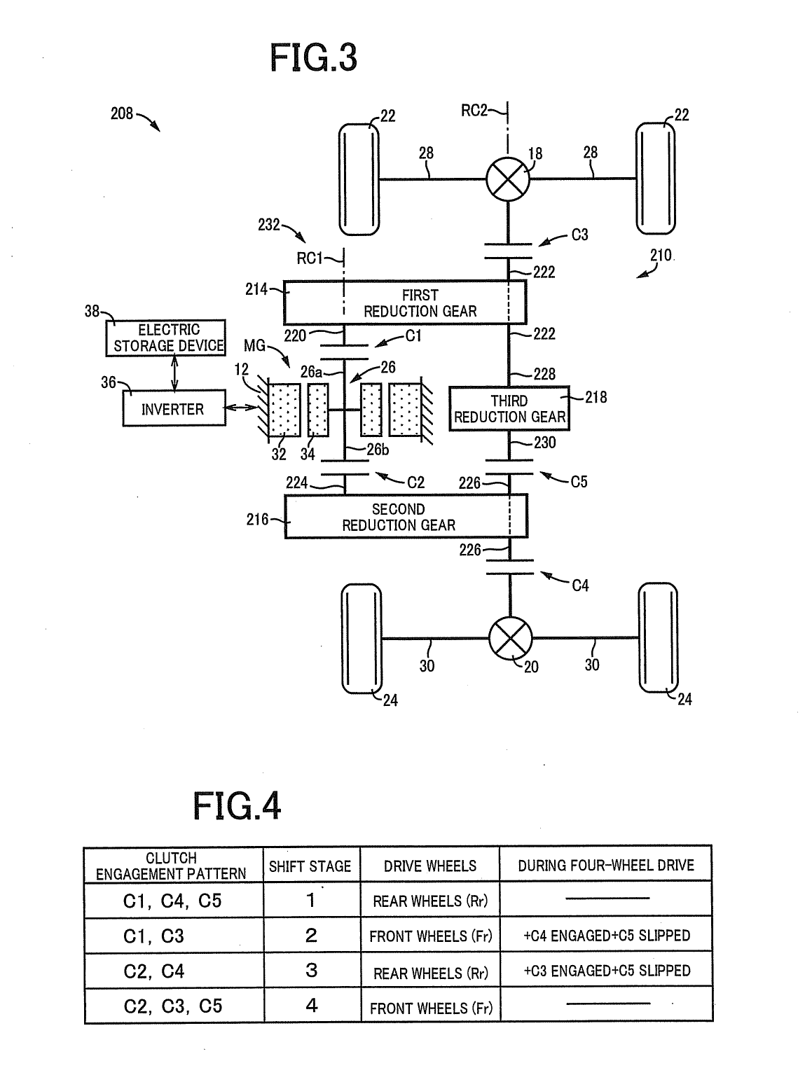

In the description of this example (third example), the points common with the first example will not be described and the points different from the first example will mainly be described. FIG. 3 is a schematic for explaining a vehicle drive device 210 included in an electric vehicle 208 (hereinafter referred to as a vehicle 208) of this example. As can be seen from comparison between FIGS. 1 and 3, the vehicle drive device 210 of this example is different from the vehicle drive device 10 of the first example in that the first reduction gear 14 is replaced with a first reduction gear 214, the second reduction gear 16 is replaced with a second reduction gear 216, and a third clutch C3, a fourth clutch C4, a fifth clutch C5, and a third reduction gear 218 are added. The vehicle drive device 210 is the same as the vehicle drive device 10 of the first example except the replacement.

As depicted in FIG. 3, the vehicle drive device 210 includes the electric motor MG, the first to fifth clutches C1 to C5, the first reduction gear 214, the second reduction gear 216, the third reduction gear 218, the first differential gear device 18, and the second differential gear device 20. The first clutch C1, the electric motor MG, and the second clutch C2 in the vehicle drive device 210 are arranged in series on a first axis RC1 that is the rotation axis of the electric motor MG. The third clutch C3, the third reduction gear 218, the fifth clutch C5, and the fourth clutch C4 are arranged in series on a second axis RC2 parallel to the first axis RC1. The first reduction gear 214 is disposed across the first axis RC1 and the second axis RC2 and, therefore, the first reduction gear 214 includes a first reduction gear input shaft 220 having the first axis RC1 as the rotation axis and a first reduction gear output shaft 222 having the second axis RC2 as the rotation axis.

The second reduction gear 216 is also disposed across the first axis RC1 and the second axis RC2 and therefore includes a second reduction gear input shaft 224 having the first axis RC1 as the rotation axis and a second reduction gear output shaft 226 having the second axis RC2 as the rotation axis.

In the first reduction gear 214, the first reduction gear input shaft 220 is coupled via the first clutch C1 to the one end portion 26a of the output rotating member 26 of the electric motor MG The first reduction gear output shaft 222 has one end coupled via the third clutch C3 to the first differential gear device 18 and the other end relatively non-rotatably coupled to a third reduction gear input shaft 228 of the third reduction gear 218. The first reduction gear 214 is the same as the first reduction gear 14 of the first example except the first reduction gear input shaft 220 having the first axis RC1 as the rotation axis and the first reduction gear output shaft 222 having the second axis RC2 as the rotation axis. Therefore, the shift ratio of the first reduction gear 214 (=rotation speed of the first reduction gear input shaft 220/rotation speed of the first reduction gear output shaft 222) is the first shift ratio γ1 same as the first reduction gear 14 of the first example. For confirmation, the one end and the other end of the first reduction gear output shaft 222 integrally rotate around the second axis RC2.

In the second reduction gear 216, the second reduction gear input shaft 224 is coupled via the second clutch C2 to the other end portion 26b of the output rotating member 26 of the electric motor MG The second reduction gear output shaft 226 has one end coupled via the fourth clutch C4 to the second differential gear device 20 and the other end coupled via the fifth clutch C5 to a third reduction gear output shaft 230 of the third reduction gear 218. The second reduction gear 216 is the same as the second reduction gear 16 of the first example except the second reduction gear input shaft 224 having the first axis RC1 as the rotation axis and the second reduction gear output shaft 226 having the second axis RC2 as the rotation axis. Therefore, the shift ratio of the second reduction gear 216 (=rotation speed of the second reduction gear input shaft 224/rotation speed of the second reduction gear output shaft 226) is the second shift ratio γ2 same as the second reduction gear 16 of the first example. For confirmation, the one end and the other end of the second reduction gear output shaft 226 integrally rotate around the second axis RC2.

The third reduction gear 218 has the same structure as the first reduction gear 14 or the second reduction gear 16 of the first example and changes a rotation speed at a constant third shift ratio γ3 (=rotation speed of the third reduction gear input shaft 228/rotation speed of the third reduction gear output shaft 230) for power transmission between the third reduction gear input shaft 228 and the third reduction gear output shaft 230. The third shift ratio γ3 is a shift ratio different from both the first shift ratio γ1 of the first reduction gear 214 and the second shift ratio γ2 of the second reduction gear 216. In this example, when the vehicle 208 runs with the power of the electric motor MG; the power may be transmitted from the third reduction gear input shaft 228 to the third reduction gear output shaft 230 or, inversely, the power may be transmitted from the third reduction gear output shaft 230 to the third reduction gear input shaft 228.

The third clutch C3, the fourth clutch C4, and the fifth clutch C5 are the same wet multi-plate type hydraulic friction engagement devices as the first clutch C1 and the second clutch C2 described in the first example and are engaged, released, and slipped by hydraulic control. The third clutch C3 interposed between the first reduction gear 214 and the front wheels 22 as depicted in FIG. 3 acts as a third power connecting/disconnecting device selectively interrupting the power transmission between the first reduction gear 214 and the front wheels 22. In other words, the first reduction gear 214 is coupled to the front wheels 22 in a power connectable/disconnectable manner. The fourth clutch C4 interposed between the second reduction gear 216 and the rear wheels 24 acts as a fourth power connecting/disconnecting device selectively interrupting the power transmission between the second reduction gear 216 and the rear wheels 24. In other words, the second reduction gear 216 is coupled to the rear wheels 24 in a power connectable/disconnectable manner. The fifth clutch C5 interposed between the second reduction gear 216 and the third reduction gear 218 acts as a fifth power connecting/disconnecting device selectively interrupting the power transmission between the second reduction gear 216 and the third reduction gear 218. In other words, the second reduction gear 216 and the third reduction gear 218 are coupled to each other in a power connectable/disconnectable manner.

Describing the power transmission path of the vehicle drive device 210 configured in this way, the one end portion 26a of the output rotating member 26 of the electric motor MG is coupled to the front wheels 22 sequentially through the first clutch C1, the first reduction gear 214, the third clutch C3, the first differential gear device 18, and the first drive axles 28 in series. On the other hand, the other end portion 26b of the output rotating member 26 of the electric motor MG is coupled to the rear wheels 24 sequentially through the second clutch C2, the second reduction gear 216, the fourth clutch C4, the second differential gear device 20, and the second drive axles 30 in series. The front wheel 22 side of the first reduction gear 214, i.e., the first reduction gear output shaft 222, and the rear wheel 24 side of the second reduction gear 216, i.e., the second reduction gear output shaft 226, are coupled to each other through the fifth clutch C5 and the third reduction gear 218 in series.

In other words, the one end portion 26a of the output rotating member 26 of the electric motor MG is coupled to the front wheels 22 sequentially through the first clutch C1, the first reduction gear 214, and the third clutch C3 in series, and is coupled to the rear wheels 24 sequentially through the first clutch C1, the first reduction gear 214, the third reduction gear 218, the fifth clutch C5, and the fourth clutch C4 in series. The other end portion 26b of the output rotating member 26 of the electric motor MG is coupled to the rear wheels 24 sequentially through the second clutch C2, the second reduction gear 216, and the fourth clutch C4 in series, and is coupled to the front wheels 22 sequentially through the second clutch C2, the second reduction gear 216, the fifth clutch C5, the third reduction gear 218, and the third clutch C3 in series. Therefore, the fifth clutch C5 selectively interrupts the power transmission from the first clutch C1 to the rear wheels 24 in the power transmission path from the one end portion 26a of the output rotating member 26 to the rear wheels 24 and selectively interrupts the power transmission from the second clutch C2 to the front wheels 22 in the power transmission path from the other end portion 26b of the output rotating member 26 to the front wheels 22.

FIG. 4 is an engagement table for explaining a relationship between alternatively established shift stages and engagement states of the first to fifth clutches C1 to C5 in a gear shifting device 232 made up of the first to fifth clutches C1 to C5, the first reduction gear 214, the second reduction gear 216, and the third reduction gear 218. As depicted in FIG. 4, the gear shifting device 232 acts as a four-speed transmission. Specifically, a first shift stage G1 is established by engaging the first clutch C1, the fourth clutch C4, and the fifth clutch C5 and releasing the second clutch C2 and the third clutch C3; a second shift stage G2 is established by engaging the first clutch C1 and the third clutch C3 and releasing the second clutch C2, the fourth clutch C4, and the fifth clutch C5; a third shift stage G3 is established by engaging the second clutch C2 and the fourth clutch C4 and releasing the first clutch C1, the third clutch C3, and the fifth clutch C5; and a fourth shift stage G4 is established by engaging the second clutch C2, the third clutch C3, and the fifth clutch C5 and releasing the first clutch C1 and the fourth clutch C4. At the first shift stage G1, the power of the electric motor MG is transmitted to the rear wheels 24 and the shift ratio of the gear shifting device 232 in this case is the product of the first shift ratio γ1 and the third shift ratio γ3. At the second shift stage G2, the power of the electric motor MG is transmitted to the front wheels 22 and a shift ratio of the gear shifting device 232 in this case is the first shift ratio γ1. At the third shift stage G3, the power of the electric motor. MG is transmitted to the rear wheels 24 and the shift ratio of the gear shifting device 232 in this case is the second shift ratio γ2. At the fourth shift stage G4, the power of the electric motor MG is transmitted to the front wheels 22 and the shift ratio of the gear shifting device 232 in this case is the product of the second shift ratio γ2 and the inverse of the third shift ratio γ3. The numbers of the first to fourth shift stages G1 to G4 are given for convenience and the first to fourth shift stages G1 to G4 are not arranged in order of magnitude of the shift ratio.

When the second shift stage G2 is established, the fourth clutch C4 is engaged and the fifth clutch C5 is slipped so that the power of the electric motor MG is transmitted not only to the front wheels 22 but also to the rear wheels 24. Therefore, the vehicle 208 is put into the four-wheel drive state. In this case, the slipped clutch may be changed such that the fourth clutch C4 is slipped while the fifth clutch C5 is engaged. If the third shift stage G3 is established, the third clutch C3 is engaged and the fifth clutch C5 is slipped so that the power of the electric motor MG is transmitted not only to the rear wheels 24 but also to the front wheels 22. Therefore, the vehicle 208 is put into the four-wheel drive state. In this case, the slipped clutch may be changed such that the third clutch C3 is slipped while the fifth clutch C5 is engaged. The fifth clutch C5 is engaged or slipped to put the vehicle 208 into the four-wheel drive state and therefore may be referred to as a four-wheel drive power connecting/disconnecting device.

The vehicle drive device 210 of this example has the following effect in addition to the effects (A1) and (A2) of the first example described above. According to this example, the one end portion 26a of the output rotating member 26 of the electric motor MG is coupled to the front wheels (first drive wheels) 22 sequentially through the first clutch C1, the first reduction gear 214, and the third clutch C3 in series, and is coupled to the rear wheels (second drive wheels) 24 sequentially through the first clutch C1, the first reduction gear 214, the third reduction gear 218, the fifth clutch C5, and the fourth clutch C4 in series. The fifth clutch C5 selectively interrupts the power transmission from the first clutch C1 to the rear wheels 24 in the power transmission path from the one end portion 26a of the output rotating member 26 to the rear wheels 24. Therefore, if the fourth clutch C4 is engaged in a running state of transmitting the power of the electric motor MG from the one end portion 26a of the output rotating member 26 to the front wheels 22, the power of the electric motor MG can selectively be transmitted by the fifth clutch C5 to the rear wheels 24 as well, thereby putting the vehicle 208 into the four-wheel drive state.

According to this example, the other end portion 26b of the output rotating member 26 of the electric motor MG is coupled to the rear wheels 24 sequentially through the second clutch C2, the second reduction gear 216, and the fourth clutch C4 in series, and is coupled to the front wheels 22 sequentially through the second clutch C2, the second reduction gear 216, the fifth clutch C5, the third reduction gear 218, and the third clutch C3 in series. The fifth clutch C5 selectively interrupts the power transmission from the second clutch C2 to the front wheels 22 in the power transmission path from the other end portion 26b of the output rotating member 26 to the front wheels 22. Therefore, if the third clutch C3 is engaged in a running state of transmitting the power of the electric motor MG from the other end portion 26b of the output rotating member 26 to the rear wheels 24, the power of the electric motor MG can selectively be transmitted by the fifth clutch C5 to the front wheels 22 as well, thereby putting the vehicle 208 into the four-wheel drive state. In other words, if the vehicle 208 is put into the four-wheel drive state by the fifth clutch C5, a gear change can be made between the electric motor MG and the front/rear wheels 22, 24 by the first clutch C1 and the second clutch C2.

According to this example, the one end portion 26a of the output rotating member 26 of the electric motor MG is coupled to the front wheels 22 sequentially through the first clutch C1, the first reduction gear 214, and the third clutch C3 while the one end portion 26b of the output rotating member 26 is coupled to the rear wheels 24 sequentially through the second clutch C2, the second reduction gear 216, and the fourth clutch C4. The first reduction gear output shaft 222 acting as a rotating member on the front wheel 22 side of the first reduction gear 214 and the second reduction gear output shaft 226 acting as a rotating member on the rear wheel 24 side of the second reduction gear 216 are coupled to each other through the fifth clutch C5 and the third reduction gear 218 in series. Therefore, the vehicle drive device 210 can alternatively establish the first shift stage G1 with the one end portion 26a of the output rotating member 26 coupled through the first reduction gear 214 and the third reduction gear 218 in series to the rear wheels 24, the second shift stage G2 with the one end portion 26a of the output rotating member 26 coupled through the first reduction gear 214 to the front wheels 22, the third shift stage G3 with the other end portion 26b of the output rotating member 26 coupled through the second reduction gear 216 to the rear wheels 24, and the fourth shift stage G4 with the other end portion 26b of the output rotating member 26 coupled through the second reduction gear 216 and the third reduction gear 218 in series to the front wheels 22, gear changes can be made in a total of four speeds. When the second shift stage G2 or the third shift stage G3 is established, the fifth clutch C5 can be slipped to transmit power so as to put the vehicle 208 into the four-wheel drive state.

Although the examples of the present invention has been described in detail with reference to the drawings, these are merely an embodiment and the present invention can be implemented in variously modified and improved forms based on the knowledge of those skilled in the art.

For example, although the clutches C1 to C5 are wet multi-plate type hydraulic friction engagement devices in the first to third examples, the clutches C1 to C5 are not particularly limited in terms of the operational type given that the clutches are power connecting/disconnecting devices capable of connecting/disconnecting power transmission, and may be dry clutches or may be magnetic-powder-type, electromagnetic-type, and mechanical-type engagement devices such as powder (magnetic powder) clutches, electromagnetic clutches, and meshing type dog clutches.

Although the front wheels 22 correspond to the first drive wheels of the present invention and the rear wheels 24 correspond to the second drive wheels of the present invention in the first to third examples, conversely, the front wheels 22 may correspond to the second drive wheels of the present invention and the rear wheels 24 may correspond to the first drive wheels of the present invention.

Although the transmission 112 is a two-speed automatic transmission in the second example, the transmission 112 may be an automatic transmission with three or more speeds.

Although the shift ratio corresponding to the first-speed shift stage of the transmission 112 is the same as the second shift ratio γ2 of the second reduction gear 16 in the second example, the shift ratio corresponding to the second-speed shift stage instead of the fist-speed shift stage may be the same as the second shift ratio γ2 of the second reduction gear 16.

Although the transmission 112 is a stepped transmission in the second example, the transmission 112 may be a continuously variable transmission (CVT) capable of continuously varying the shift ratio. If the transmission 112 is a continuously variable transmission, the second shift ratio γ2 of the second reduction gear 16 is preferably included in a shift ratio variation range.

Although the vehicle drive device 110 of the second example has the transmission 112 disposed between the one end portion 26a of the output rotating member 26 of the electric motor MG and the front wheels 22, the second reduction gear 16 may further be replaced with a transmission capable of varying a shift ratio. If two transmissions are disposed in this way, the shift stages of the respective transmissions are preferably set in advance such that the shift ratios become the same as each other at any shift stages selected by the respective transmissions.

Although the first reduction gear 14 and the first differential gear device 18 are devices separated from each other in the first example, the first reduction gear 14 and the first differential gear device 18 may make up one device having the respective functions together. Although the second reduction gear 16 and the second differential gear device 20 are devices separated from each other, the second reduction gear 16 and the second differential gear device 20 may make up one device having the respective functions together. The same applies to the second example and the transmission 112 and the first differential gear device 18 may make up one device having the respective functions together.

Although the fifth clutch C5 is interposed between the second reduction gear 216 and the third reduction gear 218 in FIG. 3 of the third example, the fifth clutch C5 may not be interposed at this position and may be interposed between the first reduction gear 214 and the third reduction gear 218.

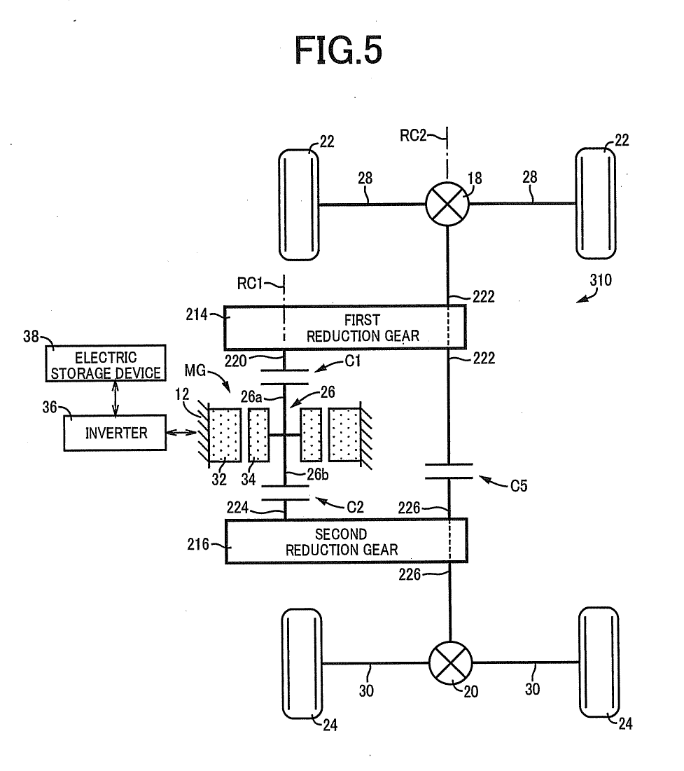

Although the vehicle drive device 210 includes the third clutch C3, the fourth clutch C4, and the third reduction gear 218 in the third example, the vehicle drive device 210 may be configured without the third clutch C3, the fourth clutch C4, and the third reduction gear 218 as depicted in FIG. 5. In a vehicle drive device 310 without the third clutch C3, the fourth clutch C4, and the third reduction gear 218 depicted in FIG. 5, the one end portion 26a of the output rotating member 26 of the electric motor MG is coupled via the first clutch C1 to the front wheels 22 in the power transmission path and is coupled to the rear wheels 24 through the first clutch C1 and the fifth clutch C5 in series at the same shift ratio as the shift ratio between the one end portion 26a and the front wheels 22. The other end portion 26b of the output rotating member 26 of the electric motor MG is coupled via the second clutch C2 to the rear wheels 24 and is coupled to the front wheels 22 through the second clutch C2 and the fifth clutch C5 in series at the same shift ratio as the shift ratio between the other end portion 26b and the rear wheels 24. In the vehicle drive device 310 of FIG. 5, either the first clutch C1 or the second clutch C2 is engaged and the other is released so that the power of the electric motor MG is transmitted to at least either the front wheels 22 or the rear wheels 24. The vehicle drive device 310 is shifted by switching the engaged clutch between the first clutch C1 and the second clutch C2. While only either the first clutch C1 or the second clutch C2 is engaged, the engagement of the fifth clutch C5 results in the four-wheel drive state, in which the power of the electric motor MG is transmitted to both the front wheels 22 and the rear wheels 24, and the release of the fifth clutch C5 results in a two-wheel drive state, in which the power of the electric motor MG is transmitted to only either the front wheels 22 or the rear wheels 24.

Although each of the first reduction gears 14, 214, the second reduction gears 16, 216, and the third reduction gear 218 reduces and transmits the rotation speed of the input shaft to the output shaft in the first to third examples, conversely, the gears may increase and transmit the rotation speed of the input shaft to the output shaft. One of the first shift ratio γ1, the second shift ratio γ2, and the third shift ratio γ3 may be one.

Although each of the electric motor MG the first clutch C1, and the second clutch C2 is a mechanically independent constituent element of the vehicle drive device 10, 110, or 210 in the first to third examples, the constituent elements may not mechanically be independent of each other and, for example, the electric motor MG the first clutch C1, and the second clutch C2 may make up one device including those functions.

### NOMENCLATURE OF ELEMENTS

10, 110, 210: vehicle drive device

14, 214: first reduction gear

16, 216: second reduction gear

22: front wheels (first drive wheels)

24: rear wheels (second drive wheels)

26: output rotating member

26a: one end portion of the output rotating member 26

26b: other end portion of the output rotating member 26

112: transmission

218: third reduction gear

MG: electric motor

C1: first clutch (first power connecting/disconnecting device)

C2: second clutch (second power connecting/disconnecting device)

C3: third clutch (third power connecting/disconnecting device)

C4: fourth clutch (fourth power connecting/disconnecting device)

C5: fifth clutch (fifth power connecting/disconnecting device, four-wheel drive power connecting/disconnecting device)

1. A vehicle drive device comprising: an electric motor as a drive force source for running,
the vehicle drive device further comprising one end portion of an output rotating member of the electric motor being coupled to first drive wheels via a first power connecting/disconnecting device selectively interrupting power transmission, the other end portion of the output rotating member being coupled to second drive wheels through a second power connecting/disconnecting device selectively interrupting power transmission at a shift ratio different from a shift ratio between the one end portion and the first drive wheels, and
the first power connecting/disconnecting device and the second power connecting/disconnecting device being alternatively put into a power transmittable state of transmitting power so as to shift gears between the first drive wheels or the second drive wheels and the electric motor.

2. The vehicle drive device of claim 1, wherein
the one end portion of the output rotating member is coupled through the first power connecting/disconnecting device and a four-wheel drive power connecting/disconnecting device in series to the second drive wheels, and wherein
the four-wheel drive power connecting/disconnecting device selectively interrupts power transmission from the first power connecting/disconnecting device to the second drive wheels.

3. The vehicle drive device of claim 2, wherein
the other end portion of the output rotating member is coupled through the second power connecting/disconnecting device and the four-wheel drive power connecting/disconnecting device in series to the first drive wheels, and wherein
the four-wheel drive power connecting/disconnecting device selectively interrupts power transmission from the second power connecting/disconnecting device to the first drive wheels.

4. The vehicle drive device of claim 1, wherein
a transmission for varying a shift ratio is disposed between the one end portion of the output rotating member and the first drive wheels, and wherein
the transmission is shifted to set a shift ratio between the one end portion of the output rotating member and the first drive wheels and a shift ratio between the other end portion of the output rotating member and the second drive wheels to the same shift ratio as each other.

5. The vehicle drive device of claim 1, wherein
the one end portion of the output rotating member is coupled to the first drive wheels sequentially through the first power connecting/disconnecting device, a first reduction gear, and a third power connecting/disconnecting device selectively interrupting power transmission, wherein the other end portion of the output rotating member is coupled to the second drive wheels sequentially through the second power connecting/disconnecting device, a second reduction gear, and a fourth power connecting/disconnecting device selectively interrupting power transmission, and wherein
the first drive wheel side of the first reduction gear and the second drive wheel side of the second reduction gear are coupled to each other through a fifth power connecting/disconnecting device selectively interrupting power transmission and a third reduction gear in series.
